(19) United States
(12) Patent Application Publication
(10) Pub. No.: US 2010/0251293 A1
(43) Pub. Date: Sep. 30, 2010

(54) NETWORK STREAMING OF A VIDEO MEDIA FROM A MEDIA SERVER TO A MEDIA CLIENT

(75) Inventors: Eric Riggert, Lake Forest, CA (US); Martin Martinez, Ladera Ranch, CA (US)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/416,071

(22) Filed: Mar. 31, 2009

(51) Int. Cl. G06F 13/00; H04N 7/173; H04N 5/58; H04J 3/16

(52) U.S. Cl. 725/37; 725/116; 348/603; 370/468; 348/E05.12

(57) ABSTRACT

Adjusting utilization of network bandwidth in a network comprising a media server and a media client is provided. The media client is connected to a display screen, and a video media is streamed from the media server to the media client. Light on at least a portion of the display screen is measured, and an indication of the measured light intensity is sent to the media server. Bits of the streaming video media are then adjusted in accordance with the indication, and the streaming video media with adjusted bits is received by the media client.

### BACKGROUND

1. Field

The present disclosure generally relates to streaming media in a network, and more particularly relates to network streaming of a video media from a media server to a media client.

2. Description of the Related Art

In the field of networks, network bandwidth can be limited, especially when legacy wireless technologies are used within the network. Moreover, streaming media content within a home or other network with limited bandwidth typically taxes the performance of the network, especially if the media content is High Definition video. The result is typically a poor quality playback of the media content due to insufficient total available network bandwidth, or acceptable quality media playback at the cost of reduced availability of the network for other purposes (including additional media streams).

In the case of video streaming, the latest consumer demand for ever-higher resolution (e.g., 1920×1080 or higher), and the preference for non-interlaced rendering (e.g., 1080p is typically preferred to 1080i) increase the strain on networks with limited bandwidth. In addition, with media types such as MPEG-2 streams having a playback rate such as 20 Mbps, the problem of limited bandwidth is further exacerbated. This problem can become more severe as technology advances, and higher resolutions of video content are realized.

Thus, there is a need for systems and methods for reducing the foregoing described problems of limited network bandwidth.

### SUMMARY OF THE INVENTION

Disclosed embodiments describe a method and system for adjusting utilization of network bandwidth in a network comprising a media server and a media client, the media client being connected to a display screen, in which a video media is streamed from the media server to the media client. Certain disclosed embodiments provide for measuring a lighting intensity on at least a portion of the display screen, and adjusting bits of the streaming video media in accordance with an indication of the lighting intensity.

In one aspect of the disclosure, adjusting utilization of network bandwidth in a network comprising a media server and a media client is provided. The media client is connected to a display screen, and a video media is streamed from the media server to the media client. In this aspect, a lighting intensity on at least a portion of the display screen is measured, and an indication of the measured lighting intensity is sent to the media server. Bits of the streaming video media are then adjusted in accordance with the indication, and the streaming video media with the adjusted bits is received by the media client.

In another aspect of the disclosure, the lighting intensity is a direct lighting on the display screen. When the bits are adjusted, a number of usable bits of the streaming video media for a portion of the display screen affected by the direct lighting are reduced. In addition, a number of bits of the streaming video media for a portion of the display screen not affected by the direct lighting may be increased.

By virtue of the foregoing arrangement, it is ordinarily possible to reduce network bandwidth utilized by streaming video within a network, while maintaining a quality of the video experienced by a viewer. More specifically, because a number of usable bits of a streaming video media is reduced for portions of the display screen that are affected by a direct lighting, less bandwidth is necessary in order to stream the video media. As a result, the streaming video media utilizes less bandwidth on the network, which in turn leaves more available bandwidth for other network applications.

In an additional aspect, lighting intensity is an ambient lighting on the display screen. When adjusting the bits of the streaming video media, a determination is made as to whether a color bit depth is below or above a threshold of human visual acuity when viewing the display screen in the measured lighting intensity. In a case where the color bit depth is below the threshold of human visual acuity when viewing the display screen in the measured lighting intensity, a reduction is made to the color bit depth of the streaming video media to a color bit depth between the current color bit depth and the threshold of human visual acuity when viewing the display in the measured lighting intensity. In a case where the color bit depth of the streaming video media is determined to be above a threshold of human visual acuity when viewing the display screen in the measured lighting intensity, an increase is made to the color bit depth of the streaming video media to a color bit depth below the threshold of human visual acuity when viewing the display screen in the measured lighting intensity. In this regard, the increase in color bit depth is limited to the color bit depth of the original source media.

By virtue of the foregoing arrangement, it is ordinarily possible to reduce network bandwidth utilized by streaming video within a network, while maintaining a quality of the video experienced by a viewer. More specifically, because a color bit depth of a streaming video media is reduced towards a threshold of human visual acuity when viewing the display screen in a measured lighting intensity, less bandwidth is necessary in order to stream the video media. In addition, the picture quality of the streamed video media is maintained in the conditions of viewing the display screen under the lighting intensity. As a result, the streaming video media utilizes less bandwidth on the network, which in turn leaves more available bandwidth for other network applications.

In yet another aspect of the disclosure, in the case where the color bit depth is below the threshold of human visual acuity when viewing the display screen in the measured lighting intensity, the media server reduces the color bit depth of the streaming video to a level below the threshold of human visual acuity when viewing the display screen in the measured lighting intensity. The level is approximate, but not equal, to the threshold of human visual acuity when viewing the display screen in the measured lighting intensity. In the case where the color bit depth of the streaming video media is determined to be above a threshold of human visual acuity when viewing the display screen in the measured lighting intensity, the media server increases the color bit depth of the streaming video media to the level. In this regard, the increase in color bit depth is limited to the color bit depth of the original source media.

A user can manually perform a sending of a command to the media server to reduce the color bit depth of the streaming video media, and the user can manually perform a sending of a command to the media server to increase the color bit depth of the streaming video media. In addition, a user can manually perform a sending of a command to the media client to reduce the color bit depth of the streaming video media, and the user can manually perform a sending of a command to the media client to increase the color bit depth of the streaming video media. When the media client receives a command from the user, the media client sends the command to the media server.

The lighting intensity on the display screen can be measured periodically or continuously, so as to capture any change in lighting intensity affecting the display screen.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF DRAWINGS

FIG. 1 is a representative view of a network in which an example embodiment may be implemented.

FIG. 2 is a detailed block diagram depicting the internal architecture of the media client shown in FIG. 1.

FIG. 3 is a detailed block diagram depicting the internal architecture of the media server shown in FIG. 1.

FIG. 4 is a flowchart for illustrating a process according to an example embodiment.

FIG. 5 is a flowchart for further defining an adjusting of block 403 of FIG. 4.

FIG. 6 is a flowchart, according to another example embodiment, for further defining an adjusting of block 403 of FIG. 4.

FIG. 7 is a flowchart for illustrating a process performed by the media client shown in FIG. 1 according to an example embodiment.

FIG. 8 is a flowchart for further defining a sending of an indication of block 702 of FIG. 7.

FIG. 9 is a flowchart, according to another example embodiment, for further defining a sending of an indication of block 702 of FIG. 7.

FIG. 10 is a flowchart for illustrating a process performed by the media server shown in FIG. 1 according to an example embodiment.

FIG. 11 is a flowchart for further defining an adjusting of block 1002 of FIG. 10.

FIG. 12 is a flowchart, according to another example embodiment, for further defining an adjusting of block 1002 of FIG. 10.

### DETAILED DESCRIPTION

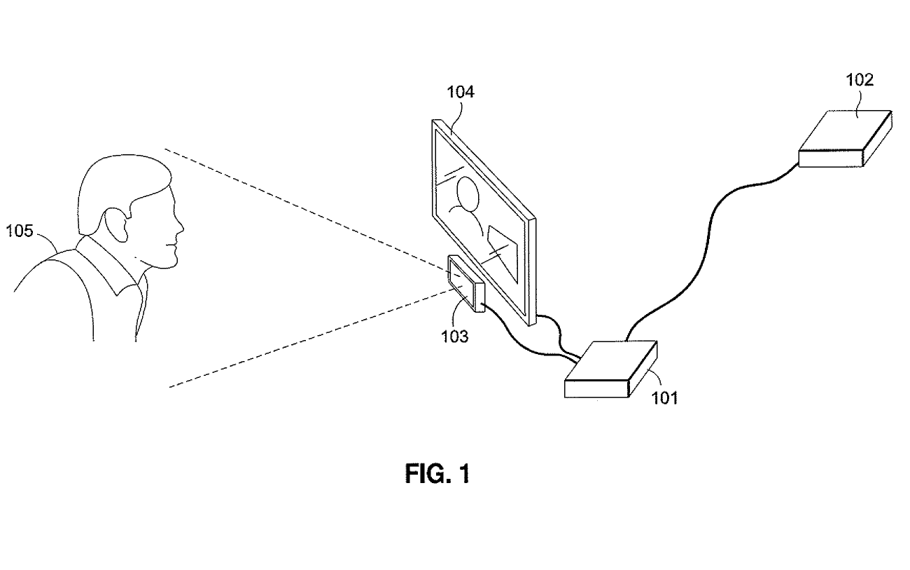

FIG. 1 is a representative view of a network in which an example embodiment may be implemented. As shown in FIG. 1, a media client 101 is connected to a media server 102. The media client 101 is shown to be connected via a wired network, such as an Ethernet network, through a wired network interface; however, in other embodiments, the media client 101 could be connected to the media server 102 through other networks, such as a Media over Coax Alliance (MoCA) network using coaxial cable, a wireless network using radio antennas, or another type of network configuration. In addition, in other embodiments, there may be more than one media server connected to the media client, there may be more than one media client connected to the media server, or there may be multiple media servers connected to multiple media clients.

Media client 101 is also connected to a display screen 104 and a light intensity measuring device 103. The display screen may be, for example, a television, a projector, or a computer screen. In FIG. 1, the display screen 104 and the light intensity measuring device 103 are shown to be external of the media client 101. However, in other embodiments, the media client and the display screen can be a single device, the media client and the light intensity measuring device can be a single device, the display screen and the light intensity measuring device can all be a single device, and the media client, the display screen and the light intensity measuring device can all be a single device. In addition, there can be multiple light intensity measuring devices, positioned around or within the display screen 104 so as to better measure any lighting on the display screen 104. For example, the light intensity measuring devices may be an array of light sensors embedded in the face of the display.

The light intensity measuring device 103 measures a light intensity for any light falling on the display screen 104. In this regard, the light intensity measuring device may utilize many known different methods to measure such a light intensity. For example, the light intensity measuring device may be a digital light meter, photodiode light sensor, Passive Infrared (PIR) sensor, or a light emitting diode (LED) light sensor. In addition, the light intensity measuring device may be, for example, a camera, either embedded in the display screen 104 facing a viewer 105, or a separate unit, which uses its light metering capabilities to measure the light intensity. However, the light intensity measuring device is not limited to the foregoing examples, and any light intensity measuring technology may be used as the light intensity measuring device.

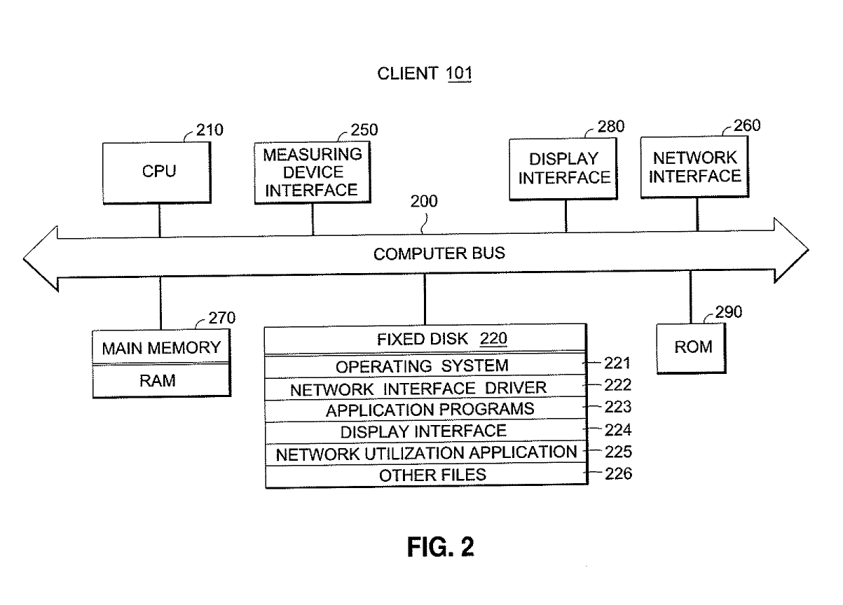

FIG. 2 is a detailed block diagram depicting the internal architecture of the media client shown in FIG. 1. As shown in FIG. 2, media client 101 includes central processing unit (CPU) 210 which interfaces with computer bus 200. Also interfacing with computer bus 200 are hard (or fixed) disk 220, measuring device interface 250, network interface 260, random access memory (RAM) 270 for use as a main run-time transient memory, display interface 280, and read only memory (ROM) 290.

RAM 270 interfaces with computer bus 200 so as to provide information stored in RAM 270 to CPU 210 during execution of the instructions in software programs such as an operating system, application programs, and interface drivers. More specifically, CPU 210 first loads computer-executable process steps from fixed disk 220, or another storage device into a region of RAM 270. CPU 210 can then execute the stored process steps from RAM 270 in order to execute the loaded computer-executable process steps. For example, data such as light intensities measured by the light intensity measuring device 103 or other information can be stored in RAM 270, so that the data can be accessed by CPU 210 during the execution of computer-executable software programs, to the extent that such software programs have a need to access and/or modify the data.

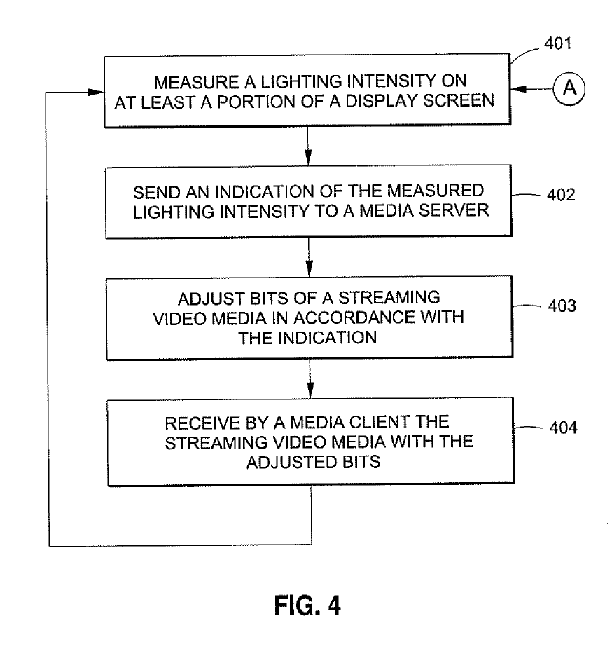

As also shown in FIG. 2, hard disk 220 contains operating system 221, network interface driver 222 for software interface to a network such as, for example, an Ethernet network, a MoCA network, a wireless network, or an Ethernet over powerline network. Hard disk 220 also contains application programs 223 such as programs for controlling the light intensity measuring device 103 or other programs. Hard disk further contains display interface 224 for software interface with a display, such as display screen 104. In addition, hard disk 220 contains network utilization application 225 for executing the processes described in more detail below in connection with FIGS. 4 to 9. Other files 226 are available for manipulation by the network utilization application 225 or other application programs.

In an example embodiment, network utilization application 225 is loaded by CPU 210 into a region of RAM 270. CPU 210 then executes the stored process steps of the network utilization application 225 from RAM 270 in order to execute the loaded computer-executable process steps. Generally, the network utilization application 225 contains processing logic configured to measure a lighting intensity on at least a portion of the display screen 104, to send an indication of the measured lighting intensity to the media server 102, and to receive the streaming video media with the adjusted bits, the bits having been adjusted in accordance with the indication. The processes executed by the network utilization application 225 as included in the media client 101 will be described in greater detail below in connection with FIGS. 7 to 9.

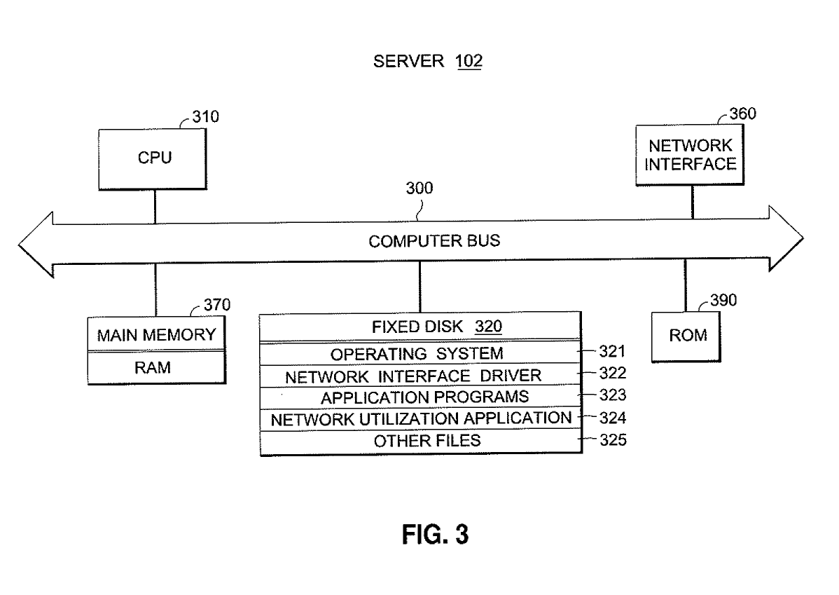

FIG. 3 is a detailed block diagram depicting the internal architecture of the media server shown in FIG. 1. As shown in FIG. 3, media server 102 includes central processing unit (CPU) 310 which interfaces with computer bus 300. Also interfacing with computer bus 300 are hard (or fixed) disk 320, network interface 360, random access memory (RAM) 370 for use as a main run-time transient memory, and read only memory (ROM) 390.

RAM 370 interfaces with computer bus 300 so as to provide information stored in RAM 370 to CPU 310 during execution of the instructions in software programs such as an operating system, application programs, and device drivers. More specifically, CPU 310 first loads computer-executable process steps from fixed disk 320, or another storage device into a region of RAM 370. CPU 310 can then execute the stored process steps from RAM 370 in order to execute the loaded computer-executable process steps. For example, data such as measurements or other information can be stored in RAM 370, so that the data can be accessed by CPU 310 during the execution of computer-executable software programs, to the extent that such software programs have a need to access and/or modify the data.

As also shown in FIG. 3, hard disk 320 contains operating system 321, network interface driver 322 for software interface to a network such as, for example, an Ethernet network, a MoCA network, a wireless network, or an Ethernet over powerline network. Hard disk 320 also contains application programs 323 such as programs for sending different types of media over different types of networks. In addition, hard disk 320 includes network utilization application 324 for executing the processes described in more detail below in connection with FIGS. 4 to 6 and 10 to 12. Other files 325 are available for manipulation by the network utilization application 324 or other application programs.

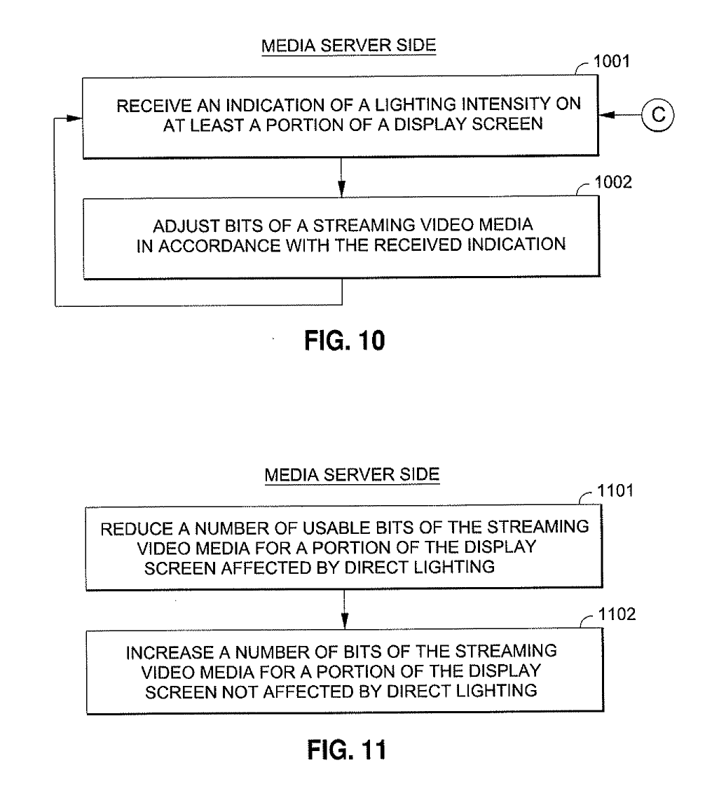

In an example embodiment, network utilization application 324 is loaded by CPU 310 into a region of RAM 370. CPU 300 then executes the stored process steps of the network utilization application 324 from RAM 370 in order to execute the loaded computer-executable process steps. Generally, the network utilization application 324 contains processing logic configured to adjust bits of the streaming video media in accordance with a received indication, in which the received indication is an indication of a lighting intensity on at least a portion of the display screen 104, measured and sent by the media client 101. The processes executed by the network utilization application 324 as included in the media server 102 will be described in greater detail below in connection with FIGS. 10 to 12.

In order to better understand the processes as described below in FIGS. 4 to 12, a general explanation of lighting intensity of an ambient lighting and a direct lighting on a display screen, how the lighting intensity affects a viewer's visual acuity of the display screen, and adjusting bits will now be provided.

Ambient lighting is any lighting surrounding the display screen, for example environment lighting, such as lighting being generated from overhead lights. In the case of ambient lighting, the light substantially covers the entire display screen. The effect from the ambient lighting on the display screen is a degree of wash out of the color bit depth of the video being displayed on the display screen. As a result, the effect of a high color bit depth is not perceived by the viewer. In this case, the color bit depth of the video may be reduced, and the reduction may not be noticeable by the viewer because of the ambient lighting. When the color bit depth is reduced to a point where the viewer can discern a reduction in color bit depth, the threshold of the viewer's visual acuity when viewing the display screen in the ambient lighting has been crossed. Accordingly, when the color bit depth of a streaming video media is said to be above a threshold of human visual acuity when viewing the display screen in a lighting intensity, then the viewer can discern a reduction in color bit depth in view of the lighting intensity. On the other hand, when the color bit depth of a streaming video media is high enough such that the resulting video quality is said to be below a threshold of human visual acuity when viewing the display screen in a lighting intensity, then the viewer cannot discern a reduction in color bit depth in view of the lighting intensity. In this regard, empirical data may be collected for varying levels of light intensity and varying levels of color bit depth, and whether a viewer can discern any difference in color bit depths for the different light intensities. This empirical data may then be used when implementing the processes described below in connection with FIGS. 4, 5, 7, 9, 10 and 12.

Direct lighting is a more focused lighting than ambient lighting (e.g., light shining through a window), and strikes directly on certain portions of the display screen. The effect of direct lighting on a display screen is a substantial wash out of the color for those affected portions of the display. As a result, a reduction can be made of a number of bits of a streaming video for the affected portions of the display screen without a viewer noticing any change in the bits of the video.

Many methods for adjusting bits of a video stream exist, and any of such methods may be used in the processes described in detail below in connection with FIGS. 4 to 12. In one example for adjusting bits, the media server 102 may locally decode the video stream, and then re-encode the video stream at a lower quality. More specifically, the video stream could re-encoded with fewer colors or reduced contrast providing a smaller (i.e., reduced bit) version of the same video, which could still be perceived the same by a viewer viewing a washed out screen. In another example, for encoded video which includes some form of color lookup table, the bits may be adjusted by modifying the table to reflect a smaller overall number of colors, by reducing the size of the color table, or by remapping the colors to fewer colors.

In an additional example for adjusting bits, the video may be decoded at the media server 102, and the least significant bit(s) of the data may be zeroed out for at least a portion of the display screen 104. Then, the data may be re-encoded with the original codec, which may provide a smaller resulting encoded stream due to lower video image complexity. On the other hand, after zeroing such bits, the video stream may be encoded by another codec which could efficiently handle large strings or zero bits in the data, such as form or run-length encoding. In another aspect, after zeroing the bits in the data, the resulting image bytes/words could be truncated (i.e., omitting the zeroed data bits) and repacked into smaller resulting data.

In yet another example for adjusting bits, for some suitable codecs, specific coefficients in the encoded video data may be modified by changing their least significant bit(s), which reduces the entropy in the resulting encoded stream. Reducing the entropy in the resulting encoded stream allows the stream to be additionally block or run-length encoded to reduce size with little change in coding complexity. The foregoing described examples of adjusting bits are not an exhaustive list of methods for adjusting bits of data, and other methods for adjusting bits of data may be used.

FIG. 4 is a flowchart for illustrating a process according to an example embodiment. More specifically, FIG. 4 shows a process for adjusting utilization of network bandwidth in a network including the media server 102 and the media client 101. As discussed above in connection with FIG. 1 the media client 101 is connected to the display screen 104, and a video media is streamed from the media server 102 to the media client 101.

As shown in FIG. 4, a lighting intensity on at least a portion of a display screen (e.g., display screen 104) is measured (block 401). In this regard, the media client 101 controls the light intensity measuring device 103 to perform light intensity measurements on the display screen 104. The lighting intensity may be measured continuously or periodically. When measuring periodically, the time between the light intensity measurements is set to be short enough so that any change in lighting can be accounted for and measured by the light intensity measuring device 103.

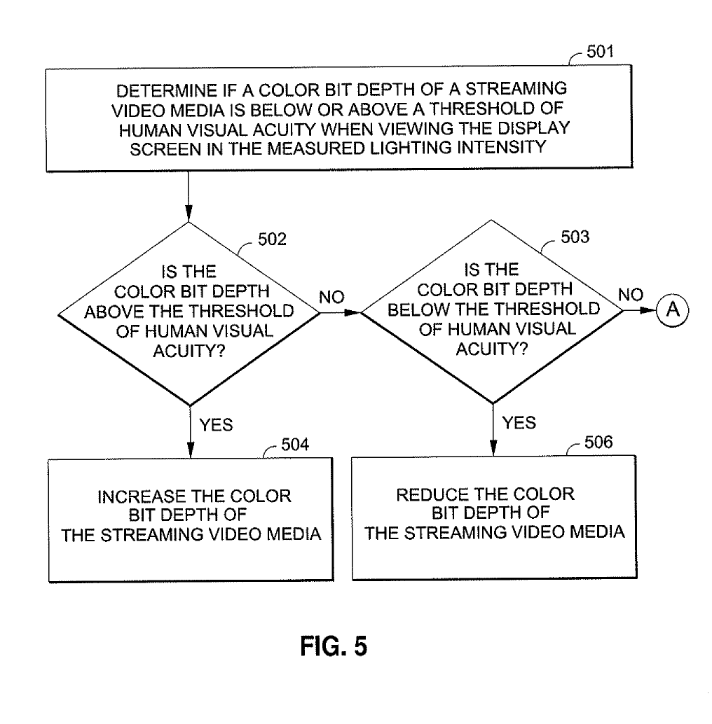

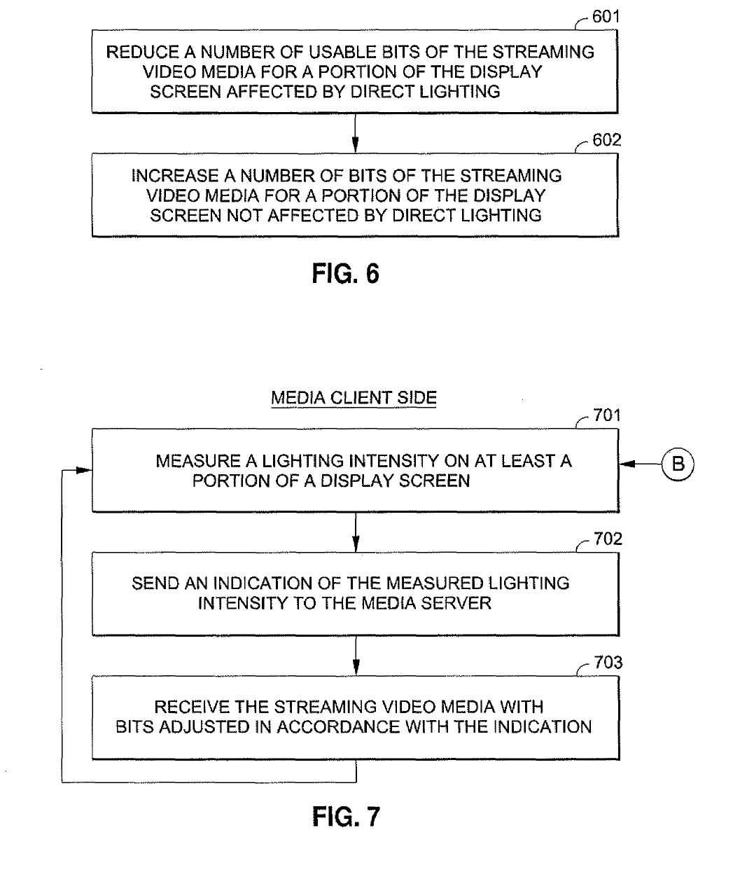

In block 402, an indication of the measured lighting intensity is sent to the media server 102. In one example embodiment, the sent indication is a command from the media client 101 to the media server 102 to adjust the bits of the streaming video media. In another example embodiment, the sent indication is the measured lighting intensity. In the case where the sent indication is the measured lighting intensity, the media server 102 determines itself whether to adjust the bits of the streaming video media. The bits of the streaming video media are then adjusted in accordance with the indication (block 403). The streaming video media with the adjusted bits is then received by the media client 101 (block 404), and displayed by the media client 101 on the display screen 104. The adjusting of the bits of the streaming video media will now be described in more detail with regard to FIGS. 5 and 6.

FIG. 5 is a flowchart for further defining the adjusting in block 403 of FIG. 4. Specifically, FIG. 5 is a flowchart for further defining the adjusting in block 403 of FIG. 4, if the measured lighting intensity is an ambient lighting on the display screen 104. As shown in FIG. 5, a color bit depth of the streaming video media is determined to be above or below a threshold of human visual acuity when viewing the display screen 104 in the measured lighting intensity (block 501). As noted above, a color bit depth above a threshold of human visual acuity corresponds with when the viewer can discern a reduction in color bit depth in view of the lighting intensity, and a color bit depth below a threshold of human visual acuity corresponds with when the viewer cannot discern a reduction in color bit depth in view of the lighting intensity. If the color bit depth of the streaming video media is determined to be above the threshold of human visual acuity when viewing the display screen 104 in the measured lighting intensity (block 502), then an increase is made to the color bit depth of the streaming video media to a color bit depth below the threshold of human visual acuity when viewing the display screen in the measured lighting intensity (block 504). In this regard, the increase in color bit depth is limited to the color bit depth of the original source media. If the color bit depth of the streaming video media is determined to be below the threshold of human visual acuity when viewing the display screen 104 in the measured lighting intensity (block 503), then a reduction is made to the color bit depth of the streaming video media to a color bit depth between the current color bit depth and the threshold of human visual acuity when viewing the display in the measured lighting intensity (block 506). If in block 503, the color bit depth of the streaming video media is determined to not be below the threshold of human visual acuity when viewing the display screen 104 in the measured lighting intensity, then the process returns to block 401 of FIG. 4.

By virtue of the foregoing example embodiments, it is ordinarily possible to reduce network bandwidth utilized by streaming video within a network, while maintaining a quality of the video experienced by a viewer. More specifically, because a color bit depth of a streaming video media is reduced towards a threshold of human visual acuity when viewing the display screen in a measured lighting intensity, less bandwidth is necessary in order to stream the video media. In addition, the picture quality of the streamed video media is maintained in the conditions of viewing the display screen under the lighting intensity. As a result, the streaming video media utilizes less bandwidth on the network, which in turn can improve quality playback when available network bandwidth is insufficient, and can leave more available bandwidth for other network applications.

In an example embodiment, in the case where the color bit depth is determined to be below the threshold of human visual acuity when viewing the display screen 104 in the measured lighting intensity as shown in block 503 of FIG. 5, the media server 102 reduces the color bit depth of the streaming video media to a level below the threshold of human visual acuity when viewing the display screen in the measured lighting intensity. The level is approximate, but not equal, to the threshold of human visual acuity when viewing the display screen in the measured lighting intensity. In the case where the color bit depth of the streaming video media is determined to be above a threshold of human visual acuity when viewing the display screen 104 in the measured lighting intensity as shown in block 502 of FIG. 5, the media server 102 increases the color bit depth of the streaming video media to the level. In this regard, the increase in color bit depth is limited to the color bit depth of the original source media. However, if the color bit depth of the streaming video media is determined to be equal to the level at the measured distance (or an acceptable range within the threshold), then the color bit depth of the streaming video media is not further adjusted. Because the color bit depth is being reduced to a level very close to the threshold of human visual acuity when viewing the display screen in the measured lighting intensity, the data size of the streaming video media can be greatly reduced, which in turn greatly reduces the network bandwidth utilized by the streaming video media. In addition, because the color bit depth is kept at a level very close to the threshold of human visual acuity when viewing the display screen in the measured lighting intensity, the quality of the video displayed on the display screen is substantially maintained.

In another example embodiment, a user can manually perform a sending of a command to the media server to reduce the color bit depth of the streaming video media, and the user can manually perform a sending of a command to the media server to increase the color bit depth of the streaming video media. In addition, a user can manually perform a sending of a command to the media client to reduce the color bit depth of the streaming video media, and the user can manually perform a sending of a command to the media client to increase the color bit depth of the streaming video media. When the media client receives a command from the user, the media client sends the command to the media server. Accordingly, the user can choose to override the adjustment of color bit depth at anytime.

FIG. 6 is a flowchart, according to another example embodiment, for further defining an adjusting of block 403 of FIG. 4. Specifically, FIG. 6 is a flowchart for further defining the adjusting in block 403 of FIG. 4, if the measured lighting intensity is a direct lighting on at least a portion of display screen 104. As shown in FIG. 6, a reduction is made to a number of usable bits of the streaming video media for a portion of the display screen 104 affected by direct lighting (block 601). In addition, an increase may be made to a number of bits of the streaming video media for a portion of the display screen not affected by the direct lighting (block 602). In this regard, the increase in number of bits of the streaming video media is limited by the original video data.

By virtue of the foregoing example embodiments, it is ordinarily possible to reduce network bandwidth utilized by streaming video within a network, while maintaining a quality of the video experienced by a viewer. More specifically, because a number of usable bits of a streaming video media is reduced for portions of the display screen that are affected by a direct lighting, less bandwidth is necessary in order to stream the video media. As a result, the streaming video media utilizes less bandwidth on the network, which in turn leaves more available bandwidth for other network applications.

FIG. 7 is a flowchart for illustrating a process performed by the media client shown in FIG. 1 according to an example embodiment. More specifically, FIG. 7 shows a process for adjusting utilization of network bandwidth in a network including the media server 102 and the media client 101 of FIG. 1. In this regard, FIG. 7 illustrates a process for adjusting utilization of network bandwidth, but is only directed to the processes executed by the media client 101. As discussed above in connection with FIG. 1, the media client 101 is connected to the display screen 104, and a video media is streamed from the media server 102 to the media client 101.

As shown in FIG. 7, a lighting intensity on at least a portion of a display screen 104 is measured (block 701). In particular, the media client 101 controls the light intensity measuring device 103 so as to measure a lighting intensity on the display screen 104. Then, the media client 101 sends an indication of the measured lighting intensity to the media server 102 (block 702). The media client 101 then receives the streaming video media with bits adjusted in accordance with the indication (block 703), and displays the streaming video media with adjusted bits on the display screen 104. The lighting intensity may be measured continuously or periodically. When measuring periodically, the time between the light intensity measurements is set to be short enough so that any change in lighting can be accounted for and measured by the light intensity measuring device 103.

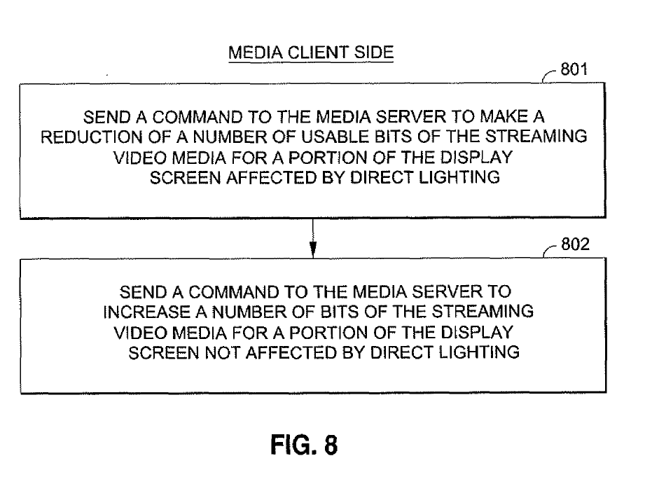

FIG. 8 is a flowchart for further defining a sending of an indication of block 702 of FIG. 7. In this example embodiment, the measured lighting intensity is a direct lighting on the display screen 104. As shown in FIG. 8, the media client 101 sends a command to the media server 102 to make a reduction of a number of usable bits of the streaming video media for a portion of the display screen 104 affected by the direct lighting (block 801). In addition, the media client 101 may send a command to the media server 102 to increase a number of bits of the streaming video media for a portion of the display screen 104 not affected by the direct lighting. In this regard, the increase in number of bits of the streaming video media is limited by the original video data.

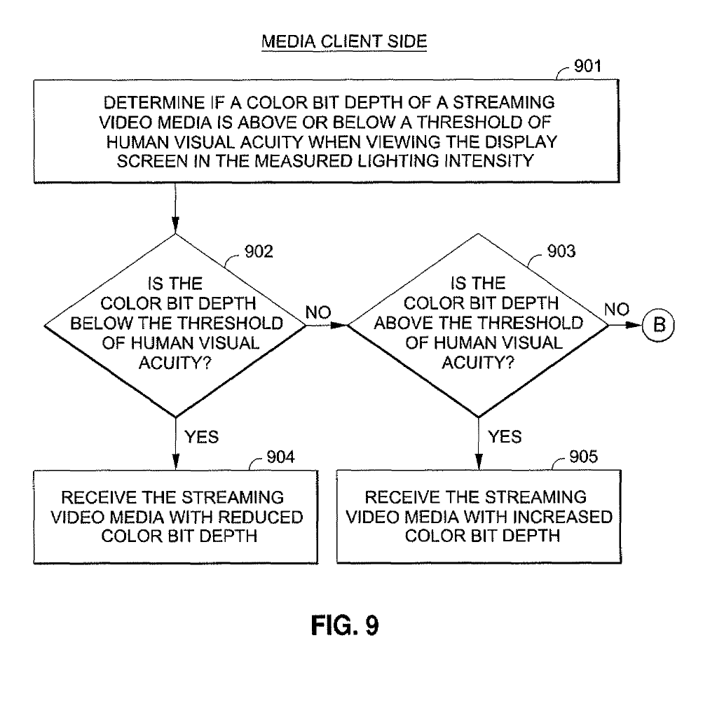

FIG. 9 is a flowchart, according to another example embodiment, for further defining a sending of an indication of block 702 of FIG. 7. In this example embodiment, the measured lighting intensity is an ambient lighting on the display screen 104. As shown in FIG. 9, a determination is made as to whether a color bit depth of the streaming video media is above or below a threshold of human visual acuity when viewing the display screen 104 in the measured lighting intensity (block 901). As noted above, a color bit depth above a threshold of human visual acuity corresponds with when the viewer can discern a reduction in color bit depth in view of the lighting intensity, and a color bit depth below a threshold of human visual acuity corresponds with when the viewer cannot discern a reduction in color bit depth in view of the lighting intensity. If the color bit depth of the streaming video media is determined to be below the threshold of human visual acuity when viewing the display screen 104 in the measured lighting intensity (block 902), then the media client 101 receives the streaming video media with a color bit depth which is reduced to a color bit depth between the current color bit depth and the threshold of human visual acuity when viewing the display screen in the measured lighting intensity (block 904). In one example embodiment, the media client 101 sends a command to the media server 102 to reduce the color bit depth of the streaming video media to a color bit depth between the current color bit depth and the threshold of human visual acuity when viewing the display screen 104 in the measured lighting intensity.

If the color bit depth of the streaming video media is determined to be above a threshold of human visual acuity when viewing the display screen in the measured lighting intensity (block 903), then the media client 101 receives the streaming video media with a color bit depth which is increased to a color bit depth below the threshold of human visual acuity when viewing the display screen in the measured lighting intensity (block 905). In one example embodiment, the media client 101 sends a command to the media server to increase the color bit depth of the streaming video media to a color bit depth below the threshold of human visual acuity when viewing the display screen in the measured lighting intensity. If in block 903, the color bit depth of the streaming video media is determined to not be above a threshold of human visual acuity when viewing the display screen in the measured lighting intensity, then the process returns to block 701 of FIG. 7.

FIG. 10 is a flowchart for illustrating a process performed by the media server shown in FIG. 1 according to an example embodiment. More specifically, FIG. 10 shows a process for adjusting utilization of network bandwidth in a network including the media server 102 and the media client 101 of FIG. 1. In this regard, FIG. 10 illustrates a process for adjusting utilization of network bandwidth, but is only directed to the roles played by the media server 102. As discussed above in connection with FIG. 1, the media client 101 is connected to the display screen 104, and a video media is streamed from the media server 102 to the media client 101.

As shown in FIG. 10, the media server 102 receives an indication of a lighting intensity on at least a portion of a display screen (block 1001). In this regard, the media client 101 has controlled the light intensity measuring device 103 to measure the lighting intensity on the display screen 104. Then, the media server 102 adjusts bits of the streaming video media in accordance with the received indication (block 1002). The lighting intensity may be measured continuously or periodically. When measuring periodically, the time between the light intensity measurements is set to be short enough so that any change in lighting can be accounted for and measured by the light intensity measuring device 103.

FIG. 11 is a flowchart for further defining an adjusting of block 1002 of FIG. 10. In this example embodiment, the measured lighting intensity is a direct lighting on the display screen 104. As shown in FIG. 11, the media server 102 reduces a number of usable bits of the streaming video media for a portion of the display screen affected by the direct lighting (block 1101). In addition, the media server 102 may increase a number of bits of the streaming video media for a portion of the display screen not affected by the direct lighting (block 1102). In this regard, the increase in number of bits of the streaming video media is limited by the original video data.

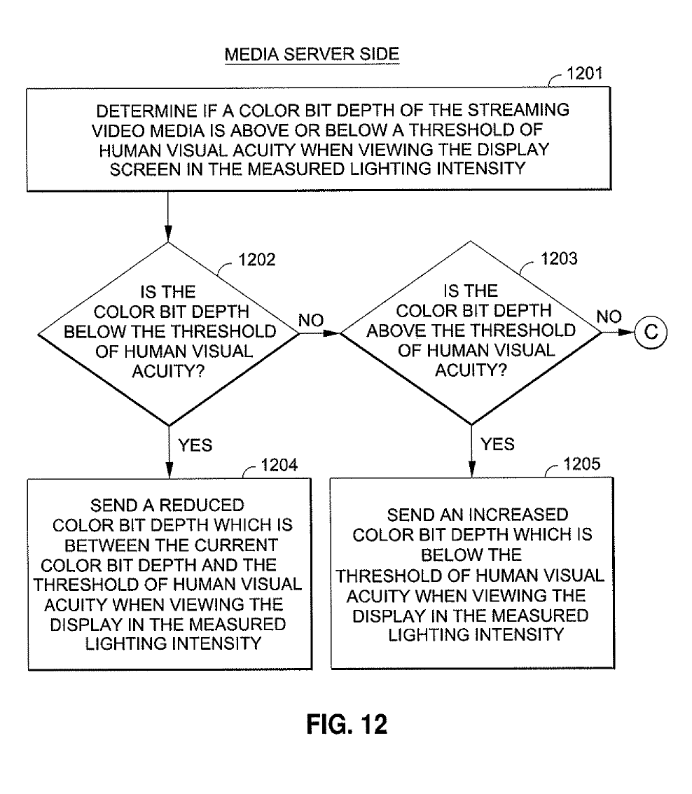

FIG. 12 is a flowchart, according to another example embodiment, for further defining an adjusting of block 1002 of FIG. 10. In this example embodiment, the measured lighting intensity is an ambient lighting on the display screen 104. As shown in FIG. 12, a determination is made as to whether a color bit depth of the streaming video media is above or below a threshold of human visual acuity when viewing the display screen 104 in the measured lighting intensity (block 1201). As noted above, a color bit depth above a threshold of human visual acuity corresponds with when the viewer can discern a reduction in color bit depth in view of the lighting intensity, and a color bit depth below a threshold of human visual acuity corresponds with when the viewer cannot discern a reduction in color bit depth in view of the lighting intensity. If the color bit depth of the streaming video media is below the threshold of human visual acuity when viewing the display screen 104 in the measured lighting intensity (block 1202), then the media server 102 sends the streaming video media with a color bit depth which is reduced to a color bit depth between the current color bit depth and the threshold of human visual acuity when viewing the display screen in the measured lighting intensity (block 1204). If the color bit depth of the streaming video media is determined to be above a threshold of human visual acuity when viewing the display screen in the measured lighting intensity (block 1203), then the media server 102 sends the streaming video media with a color bit depth which is increased to a color bit depth below the threshold of human visual acuity when viewing the display screen in the measured lighting intensity. In this regard, the increase in color bit depth is limited to the color bit depth of the original source media. If in block 1203, the color bit depth of the streaming video media is determined to not be above a threshold of human visual acuity when viewing the display screen in the measured lighting intensity, then the process returns to block 1001 of FIG. 10.

The invention has been described above with respect to particular illustrative embodiments. It is understood that the invention is not limited to the above-described embodiments and that various changes and modifications may be made by those skilled in the relevant art without departing from the spirit and scope of the invention.

What is claimed is:

1. A method for adjusting utilization of network bandwidth in a network comprising a media server and a media client, the media client being connected to a display screen, wherein a video media is streamed from the media server to the media client, the method comprising:
measuring a lighting intensity on at least a portion of the display screen;
sending an indication of the measured lighting intensity to the media server;
adjusting bits of the streaming video media in accordance with the indication; and
receiving by the media client the streaming video media with the adjusted bits.

2. A method according to claim 1, wherein the sent indication is a command from the media client to the media server to adjust the bits of the streaming video media.

3. A method according to claim 1, wherein the sent indication is the measured lighting intensity.

4. A method according to claim 1, wherein the lighting intensity is a direct lighting on the display screen, and wherein the adjusting comprises:
reducing a number of usable bits of the streaming video media for a portion of the display screen affected by the direct lighting.

5. A method according to claim 4, wherein the adjusting further comprises:
increasing a number of bits of the streaming video media for a portion of the display screen not affected by the direct lighting.

6. A method according to claim 1, wherein the lighting intensity is an ambient lighting on the display screen, and wherein the adjusting comprises:
determining if a color bit depth of the streaming video media is below or above a threshold of human visual acuity when viewing the display screen in the measured lighting intensity;
in a case where the color bit depth is determined to be below the threshold of human visual acuity when viewing the display screen in the measured lighting intensity, reducing the color bit depth of the streaming video media to a color bit depth between the current color bit depth and the threshold of human visual acuity when viewing the display screen in the measured lighting intensity;
in a case where the color bit depth of the streaming video media is determined to be above a threshold of human visual acuity when viewing the display screen in the measured lighting intensity, increasing the color bit depth of the streaming video media to a color bit depth below the threshold of human visual acuity when viewing the display screen in the measured lighting intensity.

7. A method according to claim 6, wherein in the case where the color bit depth is below the threshold of human visual acuity when viewing the display screen in the measured lighting intensity, the media server reduces the color bit depth of the streaming video to a level below the threshold of human visual acuity when viewing the display screen in the measured lighting intensity, wherein the level is approximate, but not equal, to the threshold of human visual acuity when viewing the display screen in the measured lighting intensity, and wherein in the case where the color bit depth of the streaming video media is determined to be above a threshold of human visual acuity when viewing the display screen in the measured lighting intensity, the media server increases the color bit depth of the streaming video media to the level.

8. A method according to claim 6, wherein a user can manually perform a sending of a command to the media client to reduce the color bit depth of the streaming video media, and the user can manually perform a sending of a command to the media client to increase the color bit depth of the streaming video media, and when the media client receives a command from the user, the media client sends the command to the media server.

9. A method according to claim 6, wherein a user can manually perform a sending of a command to the media server to reduce the color bit depth of the streaming video media, and the user can manually perform a sending of a command to the media server to increase the color bit depth of the streaming video media.

10. A method according to claim 1, wherein the lighting intensity is measured periodically.

11. A method according to claim 1, wherein the lighting intensity is measured continuously.

12. A method for adjusting utilization of network bandwidth in a network comprising a media server and a media client, the media client being connected to a display screen, wherein a video media is streamed from the media server to the media client, and wherein in said method the media client performs the steps of:
measuring a lighting intensity on at least a portion of the display screen;
sending an indication of the measured lighting intensity to the media server; and
receiving the streaming video media with adjusted bits,
wherein the bits are adjusted in accordance with the indication.

13. A method according to claim 12, wherein the sent indication is a command from the media client to the media server to adjust the bits of the streaming video media.

14. A method according to claim 12, wherein the lighting intensity is a direct lighting on the display screen, and wherein when the bits are adjusted in accordance with the indication, a number of usable bits of the streaming video media for a portion of the display screen affected by the direct lighting are reduced.

15. A method according to claim 14, wherein when the bits are adjusted in accordance with the indication, a number of bits of the streaming video media for a portion of the display screen not affected by the direct lighting are increased.

16. A method according to claim 12, wherein the lighting intensity is an ambient lighting on the display screen, and wherein in order to adjust the bits of the streaming video media, said media client performs the steps of:
in a case where the color bit depth is below the threshold of human visual acuity when viewing the display screen in the measured lighting intensity, based on a determination of whether a color bit depth of the streaming video media is below or above a threshold of human visual acuity when viewing the display screen in the measured lighting intensity, receiving the streaming video media with a color bit depth which is reduced to a color bit depth between the current color bit depth and the threshold of human visual acuity when viewing the display screen in the measured lighting intensity; and
in a case where the color bit depth of the streaming video media is above a threshold of human visual acuity when viewing the display screen in the measured lighting intensity, based on the determination, receiving the streaming video media with a color bit depth which is increased to a color bit depth below the threshold of human visual acuity when viewing the display screen in the measured lighting intensity.

17. A computer-readable medium on which is stored computer-executable process steps to be executed by a computer, the computer-executable process steps for adjusting utilization of network bandwidth in a network comprising a media server and a media client, the media client being connected to a display screen, wherein a video media is streamed from the media server to the media client, said computer-executable process steps comprising process steps executable to perform a method according to any of claims 12 to 16.

18. A method for adjusting utilization of network bandwidth in a network comprising a media server and a media client, the media client being connected to a display screen, wherein a video media is streamed from the media server to the media client, and wherein in said method the media server performs the steps of:
adjusting bits of the streaming video media in accordance with a received indication,
wherein the received indication is an indication of a lighting intensity on at least a portion of the display screen, measured and sent by the media client.

19. A method according to claim 18, wherein the sent indication is a command from the media client to the media server to adjust the bits of the streaming video media.

20. A method according to claim 18, wherein the sent indication is the measured lighting intensity.

21. A method according to claim 18, wherein the lighting intensity is a direct lighting on the display screen, and wherein when adjusting bits of the streaming video media in accordance with the received indication, said media server performs the steps of:
reducing a number of usable bits of the streaming video media for a portion of the display screen affected by the direct lighting.

22. A method according to claim 21, wherein when adjusting bits of the streaming video media in accordance with the received indication, said media server further performs the steps of:
increasing a number of bits of the streaming video media for a portion of the display screen not affected by the direct lighting.

23. A method according to claim 18, wherein the lighting intensity is an ambient lighting on the display screen, and wherein when adjusting the bits of the streaming video media, the media server performs the steps of.
in a case where the color bit depth is below the threshold of human visual acuity when viewing the display screen in the measured lighting intensity, based on a determination of whether a color bit depth of the streaming video media is below or above a threshold of human visual acuity when viewing the display screen in the measured lighting intensity, sending the streaming video media with a color bit depth which is reduced to a color bit depth between the current color bit depth and the threshold of human visual acuity when viewing the display screen in the measured lighting intensity; and
in a case where the color bit depth of the streaming video media is above a threshold of human visual acuity when viewing the display screen in the measured lighting intensity, based on the determination, sending the streaming video media with a color bit depth which is increased to a color bit depth below the threshold of human visual acuity when viewing the display screen in the measured lighting intensity.

24. A computer-readable medium on which is stored computer-executable process steps to be executed by a computer, the computer-executable process steps for adjusting utilization of network bandwidth in a network comprising a media server and a media client, the media client being connected to a display screen, wherein a video media is streamed from the media server to the media client, said computer-executable process steps comprising process steps executable to perform a method according to any of claims 18 to 23.

25. A media client for adjusting utilization of network bandwidth in a network comprising a media server and the media client, the media client being connected to a display screen, wherein a video media is streamed from the media server to the media client, the media client comprising processing logic configured to:
measure a lighting intensity on at least a portion of the display screen; send an indication of the measured lighting intensity to the media server; and
receive the streaming video media with adjusted bits,
wherein the bits are adjusted in accordance with the indication.

26. A media client according to claim 25, wherein the sent indication is a command from the media client to the media server to adjust the bits of the streaming video media.

27. A media client according to claim 25, wherein the sent indication is the measured lighting intensity.

28. A media client according to claim 25, wherein the lighting intensity is a direct lighting on the display screen, and wherein when the bits are adjusted in accordance with the indication, a number of usable bits of the streaming video media for a portion of the display screen affected by the direct lighting are reduced.

29. A media client according to claim 28, wherein when the bits are adjusted in accordance with the indication, a number of bits of the streaming video media for a portion of the display screen not affected by the direct lighting are increased.

30. A media client according to claim 25, wherein the lighting intensity is an ambient lighting on the display screen, and wherein the media client further comprises processing logic configured to:
in a case where the color bit depth is below the threshold of human visual acuity when viewing the display screen in the measured lighting intensity, based on a determination of whether a color bit depth of the streaming video media is below or above a threshold of human visual acuity when viewing the display screen in the measured lighting intensity, receive the streaming video media with a color bit depth which is reduced to a color bit depth between the current color bit depth and the threshold of human visual acuity when viewing the display screen in the measured lighting intensity; and
in a case where the color bit depth of the streaming video media is above a threshold of human visual acuity when viewing the display screen in the measured lighting intensity, based on the determination, receive the streaming video media with a color bit depth which is increased to a color bit depth below the threshold of human visual acuity when viewing the display screen in the measured lighting intensity.

31. A media server for adjusting utilization of network bandwidth in a network comprising the media server and a media client, the media client being connected to a display screen, wherein a video media is streamed from the media server to the media client, the media server comprising processing logic configured to:
adjust bits of the streaming video media in accordance with a received indication,
wherein the received indication is an indication of a lighting intensity on at least a portion of the display screen, measured and sent by the media client.

32. A media client according to claim 31, wherein the sent indication is a command from the media client to the media server to adjust the bits of the streaming video media.

33. A media client according to claim 31, wherein the sent indication is the measured lighting intensity.

34. A media server according to claim 31, wherein the lighting intensity is a direct lighting on the display screen, and wherein the media server further comprises processing logic configured to:
reduce a number of usable bits of the streaming video media for a portion of the display screen affected by the direct lighting.

35. A media server according to claim 34, wherein the media server further comprises processing logic configured to:
increase a number of bits of the streaming video media for a portion of the display screen not affected by the direct lighting.

36. A media server according to claim 31, wherein the lighting intensity is an ambient lighting on the display screen, and wherein the media server further comprises processing logic configured to:
in a case where the color bit depth is below the threshold of human visual acuity when viewing the display screen in the measured lighting intensity, based on a determination of whether a color bit depth is below or above a threshold of human visual acuity when viewing the display screen in the measured lighting intensity, send the streaming video media with a color bit depth which is reduced to a color bit depth between the current color bit depth and the threshold of human visual acuity when viewing the display screen in the measured lighting intensity; and
in a case where the color bit depth of the streaming video media is above a threshold of human visual acuity when viewing the display screen in the measured lighting intensity, based on the determination, send the streaming video media with a color bit depth which is increased to a color bit depth below the threshold of human visual acuity when viewing the display screen in the measured lighting intensity.
